(19) United States
(12) Patent Application Publication
(10) Pub. No.: US 2005/0076153 A1
(43) Pub. Date: Apr. 7, 2005

(54) System for managing applications dedicated to apparatuses connected to a network, application management method, access terminal, application server and apparatus for such a system

(76) Inventor: Erwan Nedellec, Cesson-Sevigne (FR)

Correspondence Address: James R Williams;Jamison Seltzer Harper & Williams, 2625 Wilmington Road, New Castle, PA, 16105, US

(21) Appl. No.: 10/496,596

(22) PCT Filed: Nov. 6, 2002
(86) PCT No.: PCT/FR02/03795

(30) Foreign Application Priority Data
Nov. 23, 2001 (FR) 01/15234

(51) Int. Cl. G06F 15/16

(52) U.S. Cl. 709/250

(57) ABSTRACT

The invention relates in particular to a system for managing applications dedicated to devices (16, 18, 20, 24, 26) connected to a network (10). The system comprises means (38, 40) for detecting the connection of a device (16, 18, 20, 24, 26) to the network (10), and an access terminal (28) for accessing at least one application server (34), the access terminal (28) being connected to the network (10) and comprising means (44) for downloading said applications from the application server (34). The system for managing applications further comprises means (46) for triggering the downloading means (44) to download at least one application dedicated to said device (16, 18, 20, 24, 26) on connection thereof to the network (10).

The present invention relates to a system for managing applications dedicated to devices connected to a network.

The invention relates more particularly to a system of the above kind comprising means for detecting the connection of a device to the network and an access terminal providing access to at least one application server. The access terminal is connected to the network and comprises means for downloading applications from the application server.

The invention also relates to a method of managing applications dedicated to devices connected to a network, an access terminal providing access to at least one application server and connected to a network suitable for connecting devices, and a device adapted to be connected to a network to which there are also connected at least one other device and an access terminal providing access to at least one application server.

Application management systems of the above kind exist in the prior art. For example, the OSGi forum proposes a system which executes a program for recognizing a device when the device is connected to the network and declares itself. This program consults a table of correspondences between devices liable to be connected to the network and a list of sets of devices, each set being associated with a generic Java interface. Thus different devices from the same set, for example the set of printers manufactured by different manufacturers, are associated with a common Java interface comprising Java methods providing access to functions common to the printers.

Secondly, in this system, an application server may download into an access terminal connected to the network applications dedicated to the connected devices and thereafter execute those applications in the context of using one of the devices connected to the network.

However, each device connected to the network has its own control interface that is imposed by the designer of the device. Moreover, applications specific to the device are sometimes implemented in the device itself and are downloaded to the access terminal as soon as the device is connected to the network. These dedicated applications are executed to enable a user of the system to control the corresponding device from another device connected to the network and comprising a display screen, for example.

However, in all cases, the user must know how to use each of the devices connected to the network, before being able to control and use them.

The invention aims to remedy the drawbacks of a conventional application management system by providing a system allowing use of devices connected to a network and applications dedicated to them without obliging the user to know how to use all the devices.

The invention therefore consists in a system for managing applications dedicated to devices connected to a network, said system comprising:
means for detecting the connection of a device to the network; and
an access terminal for accessing via an external information transmission network at least one application server, the access terminal being connected to the network and comprising means for downloading said applications from the application server, and said system being characterized in that it further comprises means for triggering the downloading means to download at least one application dedicated to said device on connection thereof to the network.

An application management system according to the invention is used to download applications dedicated to devices, from an application server, as soon as the devices are connected to the network. Thus the dedicated applications are not designed by the designers of the devices, but by an independent application provider, which enables them to be made uniform, for example.

The application management system according to the invention may further have one or more of the following features:
at least one application dedicated to said device is a control application for controlling that device;
the system comprises a single access portal to different services offered by the devices connected to the network, said access portal comprising means for executing applications dedicated to each connected device;
the access portal is accessible from at least one of the devices connected to the network;
the access portal comprises a unified man-machine interface for controlling connected devices and means for integrating control applications into said unified man-machine interface;
the system comprises means for detecting the disconnection of a device from the network and means for triggering the deleting of applications dedicated to said device on disconnection thereof from the network;
the system comprises storage means, accessible in read mode by the access terminal, for storing information for establishing the correspondence between each device liable to be connected to the network and a list of applications dedicated to said device;
the list of applications comprises, for each application, the universal resource locator from which that application may be downloaded by the access terminal;
the network is a local area network;
the application server is accessible by the access terminal via an external information transmission network; and
the system comprises at least one software bus implemented on the network for connecting devices thereto and to each other.

The invention also provides an application management method dedicated to devices connected to a network, the method comprising a step of detecting connection of a device to the network and being characterized in that it further comprises a step of triggering the downloading by an access terminal providing access to at least one application server of at least one application dedicated to said device on connection thereof to the network.

The application management method according to the invention may further have one ore more of the following features:
at least one application dedicated to said device is a control application for controlling the device and the method further comprises a step of integrating said control application into a unified man-machine interface for controlling devices connected to the network;
the method comprises a step of detecting disconnection of a device from the network and a step of triggering deletion by the access terminal of applications dedicated to said device on disconnection thereof from the network.

The invention also consists in an access terminal for accessing via an external information transmission network at least one application server, the access terminal being connected to a network adapted to connect devices and comprising downloading means for downloading applications from the application server, characterized in that it further comprises triggering means for triggering the downloading means to download at least one application dedicated to a device on connection thereof to the network.

The access terminal according to the invention may further have either of the following features:
it comprises means for detecting disconnection of a device from the network and triggering means for triggering deletion of applications dedicated to that device on disconnection thereof from the network;
it comprises access means for accessing in read mode storage means for storing information for establishing the correspondence between each device liable to be connected to the network and a list of applications dedicated to that device.

The invention further consists in an application server characterized in that it comprises applications dedicated to at least one device connected to a network to which is also connected an access terminal for accessing the application server, said applications being adapted to be integrated into a unified man-machine interface.

The invention finally consists in a device adapted to be connected to a network to which are also connected at least one other device and an access terminal for accessing at least one application server providing applications dedicated to devices liable to be connected to the network, characterized in that it comprises means for displaying a unified man-machine interface which comprises means for integrating at least one application dedicated to a device on connection thereof to the network.

The device of the invention my also have the feature whereby said at least one application is a control application.

The invention will be better understood in the light of the following description, which is given by way of example only and with reference to the appended drawings, in which:

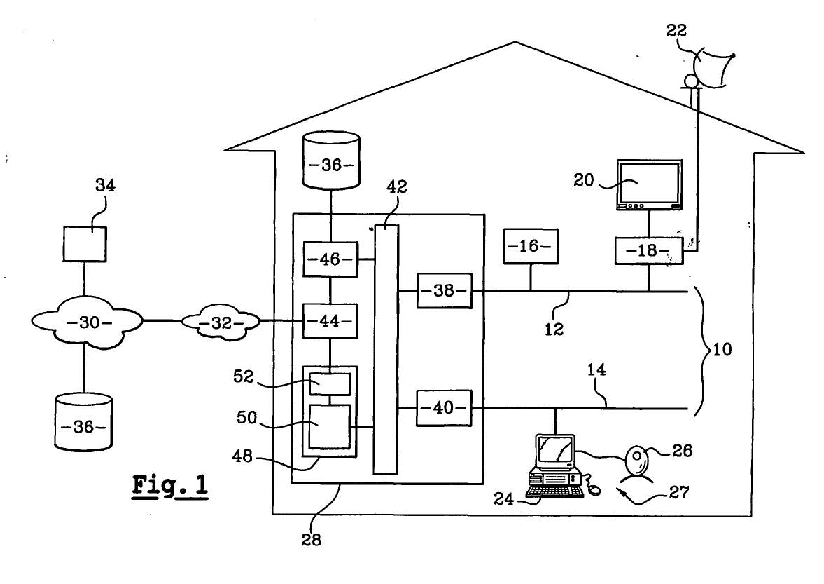

FIG. 1 is a diagram illustrating the general structure of an application management system of the invention, and

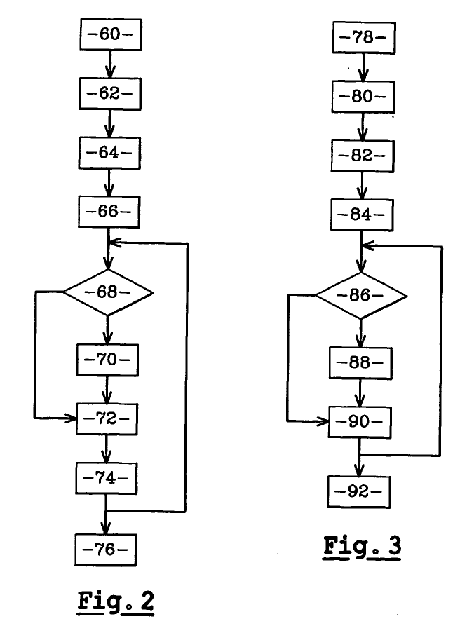

FIGS. 2 and 3 represent the successive steps of an application management method implemented in the FIG. 1 system.

The application management system represented in FIG. 1 comprises a local area network 10 comprising an IEEE 1394 local area subnetwork 12 supporting a HAVi® software bus and an Ethernet local area subnetwork 14 supporting a Jini™ software bus.

A recorder 16 is connected to the IEEE 1394 subnetwork. A digital multimedia terminal (set top box) 18 is connected to the same IEEE 1394 network. The set top box 18 is also connected to a television 20 and to a parabolic antenna for receiving digital television broadcasts.

A personal computer 24 associated with a digital camera 26 is connected to the Ethernet subnetwork 14 and comprises means for exchanging information with the Jini™ software bus, to simulate a Jini® camera. Accordingly, the combination comprising the personal computer 24 and the digital camera 26 is referred to hereinafter as the Jini® digital camera 27.

Finally, an access terminal 28 is connected to the local area network 10, i.e. to the Ethernet local area subnetwork and to the IEEE 1394 local area subnetwork.

The access terminal 28 is further connected to an external information transmission network 30 such as the Internet. This connection is conventionally provided by a xDSL link 32.

An application server 34 is also connected to the Internet 30. The application server holds a plurality of applications dedicated in particular to the devices 16, 18, 20, 24 and 26 connected to the local area network 10. For example, these dedicated applications comprise applications for controlling each of the above-mentioned devices.

Moreover, these applications are designed by a provider independent of the device manufacturers. In particular, they have a unified interface.

The access terminal 28 may access the application server 34 via the Internet 30 to download applications dedicated to devices connected to the local area network 10. To this end, the access terminal 28 is connected to a database 36 which may have a direct local connection to the access terminal 28 or be connected to it via the Internet 30, as shown in FIG. 1.

The database 36 comprises, for example, in the form of a table of correspondences, a plurality of lists of applications dedicated to devices liable to be connected to the local area network 10. Accordingly, for the Jini™ digital camera 27 connected to the Ethernet subnetwork 14 via the Jini™ software bus, the database 36 comprises a list of applications dedicated to the Jini™ digital camera 27.

In practice, the database 36 comprises, for each device liable to be connected to the local area network 10, and therefore for the Jini® digital camera 27:
the reference of the device, containing information enabling it to be identified unambiguously;
the reference of dedicated applications associated with the device, including an application for controlling the device; and
the location of each application dedicated to the device, comprising, for example, the URL of the corresponding file in the application server 34.

In the conventional way, the access terminal 28 comprises means for managing software buses implemented on the subnetworks to which it is connected. The access terminal 28 therefore comprises management means 38 for the HAVi® software bus. It also comprises management means 40 for the Jini™ software bus. The management means 38 and 40 are adapted to detect automatically the connection of a device to the local area network 10. Similarly, they are adapted to detect automatically the disconnection of a device.

The software bus management means 38 and 40 are connected to an interface 42 of the access terminal 28. This interface 42 materializes the division between the portion of the access terminal 28 connected to the local area network 10 and the portion of the access terminal 28 connected to the Internet 30.

The portion of the access terminal 28 connected to the Internet 30 comprises means 44 for downloading applications dedicated to devices connected to the local area network 10.

The access terminal 28 further comprises means 46 for triggering downloading or deleting of applications.

The triggering means 46 are connected to the interface 42 in order to receive information concerning the connection of a device to the local area network 10 or its disconnection therefrom. They are further connected to the database 36, either directly or indirectly via the downloading means 44 and the Internet 30, to establish the correspondence between the device detected as being connected or disconnected and the corresponding list of dedicated applications. Finally, the triggering means 46 are connected to the downloading means 44 to call on them when new applications dedicated to a device that has just been connected to the local area network 10 must be downloaded from the application server 34, if they are not already present in the access terminal 28.

The access terminal 28 further comprises an access portal 48 to the downloaded applications. The access portal 48 comprises means for storing applications downloaded by the access terminal 28, or at least links providing access thereto.

The access portal 28 comprises a man-machine interface 50 taking the form of an HTML page. For example, the man-machine interface 50 takes the form of a symbolic representation of the local area network 10 and the various devices liable to be connected thereto. It is accessible via the television 20, which is able to display it on its screen.

To enable a user to access applications dedicated to devices connected to the local area network 10, the access portal 48 comprises means 52 for integrating into the man-machine interface 50 applications downloaded by the means 44.

Accordingly, when a user moves a cursor over the screen of the television 20 and positions it on an icon corresponding to the Jini™ digital camera 27, a control interface for the Jini™ digital camera 27 appears on the screen if the Jini™ digital camera 27 is connected to the Ethernet subnetwork. This control interface corresponds to the control application dedicated to the Jini™ digital camera 27, that application being designed by the application provider and made available on the application server 34.

The application provider is also the provider of the man-machine interface 50, for example, with the result that the latter, integrating applications dedicated to devices connected to the local area network 10, becomes a unified control interface for the devices 16, 18, 20, 24 and 26.

The successive steps of an application management method used in the system described above on connecting a device to the local area network 10 or disconnecting it therefrom are described next with reference to FIGS. 2 and 3.

The method represented in FIG. 2 and executed on connecting a device to the local area network 10 comprises a first step 60 of plugging in the device.

During the step 60, a user plugs a device into the local area network 10, for example the Jini™ digital camera 27.

During a step 62, the Jini™ digital camera 27 spontaneously declares itself to the management means 40 of the Jini™ software bus. During this step, the Jini™ digital camera 27 transmits to the management means 40 the information identifying it unambiguously. This step constitutes automatic detection of plugging in the Jini™ digital camera 27.

Then, during a step 64, the management means 40 send the information to the triggering means 46 via the interface 42.

During a step 66, the triggering means 46 look up in the database 36 the list of applications dedicated to the Jini™ digital camera 27.

During a test step 68 that is repeated as many times as necessary, the access terminal 28 verifies, for each dedicated application from the list, whether it is already installed in the access portal 48. If it is, the next step is a step 72 described later; if it is not, the next step is a downloading step 70.

During the step 70, the downloading means 44 connect to the application server 34 and, using the URL supplied by the triggering means 46, download the corresponding dedicated application from the application server 34.

This application is integrated into the access portal 48 during the next step 72.

Finally, the man-machine interface 50 is updated during a step 74.

When all the applications dedicated to the Jini™ digital camera 27 have been downloaded and integrated into the man-machine interface 50, the next step of the process is a final step 76, starting from which a user of the system is able to control the Jini™ digital camera 27 from his television 20 via the unified man-machine interface 50 and access its functions.

The method represented in FIG. 3 is used on disconnecting a device from the local area network 10 and comprises a first step 78 of unplugging the device.

This first step 78 is followed by three steps 80, 82, and 84 that are identical to the steps 62, 64, and 66, respectively, of the method described above.

The step 84 is followed by a test step 86 during which the access terminal 28 verifies, for each of the dedicated applications in the list sent by the triggering means 46, if the latter provides for controlling other devices that are still connected to the local area network 10.

If the dedicated application is no longer used for other connected devices, the next step is a step 88 during which the access terminal 28 de-installs the application.

After the step 88, or after the step 86 if the dedicated application is being used for another connected device, the next step is a step 90 during which the man-machine interface 50 is updated so that applications dedicated to the device that has been unplugged no longer appear on the screen of the television 20.

When all the applications dedicated to the device that has been unplugged have been either de-installed or left for use by other connected devices, the next step is a final step 92 during which the triggering means 46 are set to a standby state awaiting a new triggering event.

It is clear that the application management system described above provides an easy and user friendly way for a user to control devices connected to a local area network. This is because the man-machine interface 50 that the user is able to view on the screen of the television 20 offers unified access for controlling the connected devices. Thus the user no longer needs to know how to use each device.

1-17. (canceled)

18. A system for managing applications dedicated to devices for connection to a local area network, the system comprising:
a) a detector for detecting the connection of a device to the local area network;
b) an access terminal connected to the local area network and capable of accessing at least one application server storing dedicated applications for the devices via an external information transmission network, the access terminal being capable of downloading from the application server at least one application dedicated to the device whose connection to the local area network is detected by the detector;
c) an access portal to different services offered by the devices for connection to the local area network, the access portal being connected to the local area network and capable of executing applications dedicated to the devices for connection to the local area network; and
d) a trigger for triggering download into the access portal of the application dedicated to the device whose connection to the local area network is detected by the detector, only if the dedicated application has not already been downloaded into the access portal.

19. The application management system of claim 18, wherein at least one application dedicated to the device whose connection to the local area network is detected by the detector comprises a control application for controlling the device whose connection to the local area network is detected by the detector.

20. The application management system of claim 19, wherein the access portal is accessible from at least one device connected to the local area network.

21. The application management system of claim 20, wherein the access portal comprises a unified man-machine interface for controlling connected devices and an integration device for integrating control applications into the unified man-machine interface.

22. The application management system of claim 18, comprising a detector for detecting the disconnection of a connected device from the local area network and a trigger for triggering the deletion of applications dedicated to the connected device on disconnection thereof from the local area network.

23. The application management system of claim 18, including storage, accessible in read mode by the access terminal, capable of storing information for establishing the correspondence between each device liable to be connected to the local area network and a list of applications dedicated to each device.

24. The application management system of claim 23, wherein the list of applications comprises, for each application, a universal resource locator from which that application may be downloaded by the access terminal.

25. The application management system of claim 18, comprising at least one software bus implemented on the local area network for connecting devices thereto and to each other.

26. An application management method dedicated to devices for connection to a local area network, the method comprising:
a) detecting the connection of a device to the local area network;
b) downloading by an access terminal from at least one remote application server storing a dedicated applications for the devices via an external information transmission network at least one application dedicated to the device whose a connection to the local area network is detected by the detector;
c) triggering download of the application dedicated to the device whose connection to the local area network is detected by the detector into an access portal to different services proposed by the devices connected to the local area network only if the dedicated application has not already been downloaded into the access portal, the access portal being connected to the local area network and capable of executing applications dedicated to the connected devices.

27. The application management method of claim 26, further comprising, before the triggering step, verifying whether the dedicated application is already installed in the access portal.

28. The application management method of claim 27, wherein at least one application dedicated to the device whose connection to the local area network is detected by the detector, includes a control application for controlling the device whose connection to the local area network is detected by the detector and further comprising integrating the control application into a unified man-machine interface for controlling connected devices.

29. The application management method of claim 26, further comprising detecting disconnection of a connected device from the local area network and triggering deletion by the access terminal of applications dedicated to the connected device on disconnection thereof from the local area network.

30. An access terminal connected to a local area network and for accessing at least one remote application server storing applications dedicated to devices for connection to the local area network via an external information transmission network, the access terminal being capable of downloading from the application server at least one application dedicated to a device whose connection to the local area network is detected and including:
a) an access portal to services proposed by the devices for connection to the local area network and adapted to execute applications dedicated to the devices for connection; and
b) a trigger capable of triggering download into the access portal of the application dedicated to the device whose connection to the local area network is detected, only if the application has not already been downloaded into the access portal.

31. The access terminal of claim 30, including a detector for detecting disconnection of a connected device from the local area network and a trigger for triggering the deletion of applications dedicated to the connected device on disconnection thereof from the local area network.

32. The access terminal of claim 30, including access to storage in read mode for storing information for establishing correspondence between each device liable to be connected to the local area network and a list of applications dedicated to each device.

33. An application server comprising applications dedicated to at least one device or connection to a local area network to which is connected an access terminal for accessing the application server via an external information transmission network, the applications being adapted to be integrated into a unified man-machine interface.

34. A device adapted to be connected to a local area network to which are also connected at least one other device and an access terminal for accessing at least one application server providing applications dedicated to devices liable to be connected to the local area network, the device comprising a display for a unified man-machine interface that integrates at least one control application dedicated to a device on connection thereof to the local area network.

35. (canceled)
